(19) United States
(12) Patent Application Publication
(10) Pub. No.: US 2026/0180105 A1
(43) Pub. Date: Jun. 25, 2026

(54) Battery Case and Battery Module

(71) Applicant: SK On Co., Ltd., Seoul (KR)

(72) Inventor: Dae Hyeon LEE, Daejeon (KR)

(21) Appl. No.: 19/384,373

(22) Filed: Nov. 10, 2025

(30) Foreign Application Priority Data
Dec. 19, 2024 (KR) 10-2024-0191124

(51) Int. Cl. H01M 50/258; H01M 50/211; H01M 50/271; H01M 50/507

(52) U.S. Cl. CPC H01M 50/258; H01M 50/211; H01M 50/271; H01M 50/507

(57) ABSTRACT

Disclosed is a battery case. According to an embodiment of the present disclosure, the battery case includes: a main case including a main case base extending from a first side to a second side, a first main case plate coupled to the first side of the main case base, and a second main case plate forming a front surface of the battery case and coupled to the main case base; a middle case including a middle case base disposed above the main case base, and a middle case plate coupled to the second side of the middle case base; and a cover case forming a rear surface of the battery case and coupled to both the main case and the middle case.

### BACKGROUND OF THE INVENTION

### 1. Field of the Invention

The present disclosure relates to a battery case and a battery module. In particular, the present disclosure relates to a battery case and a battery module having enhanced assemblability of the case.

### 2. Description of the Related Art

Conventionally, in order to assemble a hexahedral battery case and a battery module, internal components including battery cells are required to be assembled to form a sub-battery case and a battery module, and then a case for accommodating the sub-battery case and the battery module is required to be assembled.

Typically, cases may be assembled in multiple segments. The most commonly used segmentation methods may be the 4-segment or 6-segment method.

However, the 4-segment or 6-segment method may have drawbacks. The 6-segment method requires significant man-hours for case welding and assembly, and may result in significant sunk costs due to defects in the segmented case components.

In addition, the 4-segment method has the problem that assembling the sub-battery case and battery module into the segmented case is difficult, and quality control of the segmented case components is difficult.

### SUMMARY OF THE INVENTION

An object of the present disclosure is to provide a battery case and a battery module having enhanced assemblability of the case for accommodating a cell assembly.

Another object of the present disclosure is to provide a battery case and a battery module that facilitate insertion of a cell assembly without restriction in any of the X, Y, or Z axes during seating.

Still another object of the present disclosure is to provide a battery case and a battery module that enable two axes to be fixed during seating of a cell assembly, thereby reducing assembly man-hours and facilitating assembly.

A battery case according to exemplary embodiments of the present disclosure may include: a main case including a main case base extending from a first side to a second side, a first main case plate coupled to the first side of the main case base, and a second main case plate forming a front surface of the battery case and coupled to the main case base; a middle case including a middle case base disposed above the main case base, and a middle case plate coupled to the second side of the middle case base; and a cover case forming a rear surface of the battery case and coupled to both the main case and the middle case.

The first main case plate and the second main case plate may form a peripheral surface of the battery case.

The main case base and the first main case plate may be integrally formed.

The middle case base and the middle case plate may be integrally formed.

An edge of the first side of the middle case base may be coupled to an upper end of the first main case plate, and a lower end of the middle case plate may be coupled to an edge of the second side of the main case base.

The main case and the middle case may be laser welded.

An upper end of the cover case may be coupled to a rear end of the middle case base, and a lower end of the cover case may be coupled to a rear end of the main case base.

The combined shape of the main case base and the first main case plate may be identical to the combined shape of the middle case base and the middle case plate.

A battery module according to exemplary embodiments of the present disclosure may include: a battery case; and a battery assembly accommodated in the battery case, wherein the battery case may be divided into three segments.

The battery case may include: a main case in which the battery assembly is seated and is open to the outside; a middle case coupled to the main case and covering upper and side surfaces of the battery assembly; and a cover case coupled to the main case and the middle case and covering a rear surface of the battery assembly.

The battery assembly may include a cell assembly including a plurality of battery cells, and the plurality of battery cells may be stacked along a lateral direction of the battery case.

The battery module may further include a busbar assembly coupled to the cell assembly, and the busbar assembly may form a front surface or a rear surface of the battery assembly.

The main case may include: a main case base extending from a first side to a second side; a first main case plate coupled to the first side of the main case base; and a second main case plate forming a front surface of the battery case and coupled to the main case base.

The middle case may include: a middle case base disposed above the main case base; and a middle case plate coupled to the second side of the middle case base.

An edge of the first side of the middle case base may be coupled to an upper end of the first main case plate, and a lower end of the middle case plate may be coupled to an edge of the second side of the main case base.

The main case may further include a main case through-hole formed through the second main case plate, and the main case through-hole may allow communication between the battery assembly and the exterior of the battery case.

A battery cell disposed at the outermost side of the plurality of battery cells may face an inner surface of the first main case plate.

The main case base and the first main case plate may be integrally formed, and the middle case base and the middle case plate may be integrally formed.

The main case and the middle case may be laser welded.

Based on an imaginary line that runs parallel to the longitudinal direction of the battery module and passes through the center of the battery case, the combined shape of the main case base and the first main case plate may be symmetrical to the combined shape of the middle case base and the middle case plate.

According to an embodiment of the present disclosure, a battery case and a battery module having enhanced assemblability of the case for accommodating a cell assembly may be provided.

The battery case and battery module of the present disclosure may facilitate insertion of a cell assembly without restriction in any of the X, Y, or Z axes during seating.

The battery case and battery module of the present disclosure may enable the X and Z axes to be fixed during seating of the cell assembly, thereby reducing assembly man-hours and facilitating assembly.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view illustrating a battery module according to an embodiment of the present disclosure;

FIG. 2 is an exploded perspective view illustrating the battery module shown in FIG. 1;

FIG. 3 is an exploded perspective view illustrating a case forming the battery module shown in FIG. 1;

FIG. 4 is an exploded perspective view illustrating a battery assembly forming the battery module shown in FIG. 1;

FIG. 5 is a cross-sectional view taken along line A1-A2 of the case shown in FIG. 3;

FIG. 6 is a cross-sectional view taken along line B1-B2 of the case shown in FIG. 3;

FIG. 7 is a cross-sectional view taken along line C1-C2 of the case shown in FIG. 3;

FIG. 8 is a cross-sectional view taken along line D1-D2 of the case shown in FIG. 3;

FIG. 9 is a cross-sectional view taken along line E1-E2 of the case shown in FIG. 3;

FIG. 10 is a cross-sectional view taken along line F1-F2 of the battery module shown in FIG. 1; and

FIG. 11 is a cross-sectional view taken along line G1-G2 of the battery module shown in FIG. 1.

### DETAILED DESCRIPTION OF THE INVENTION

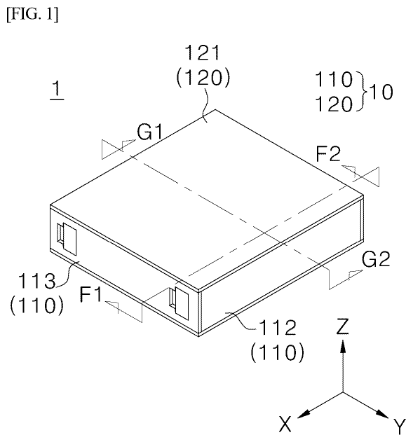

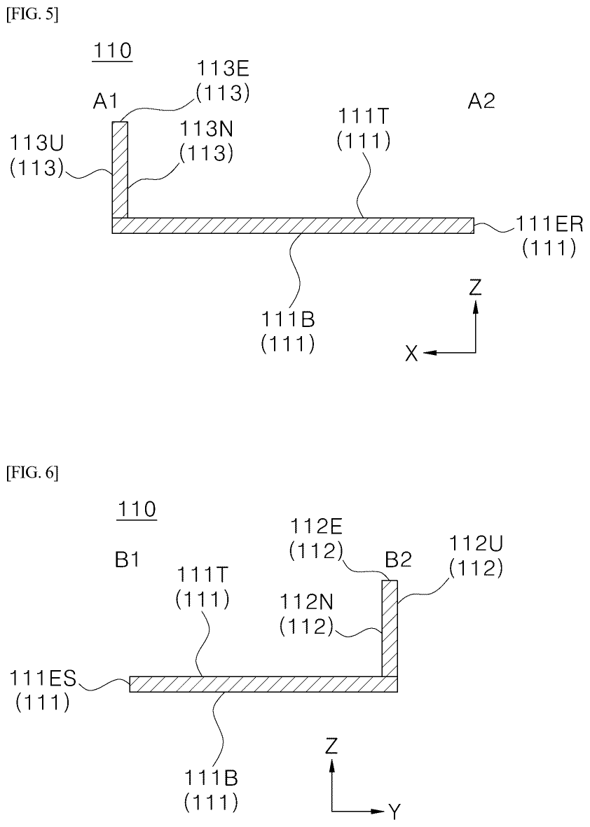

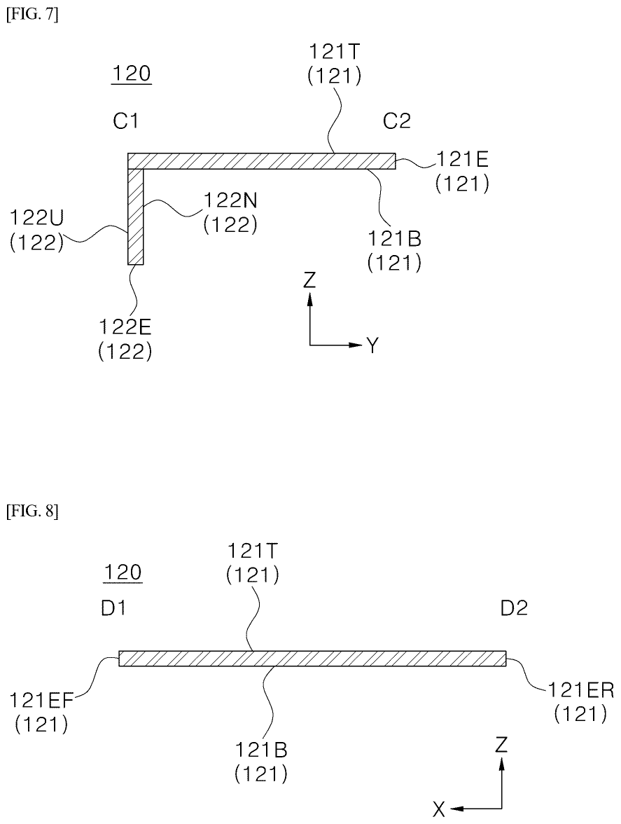

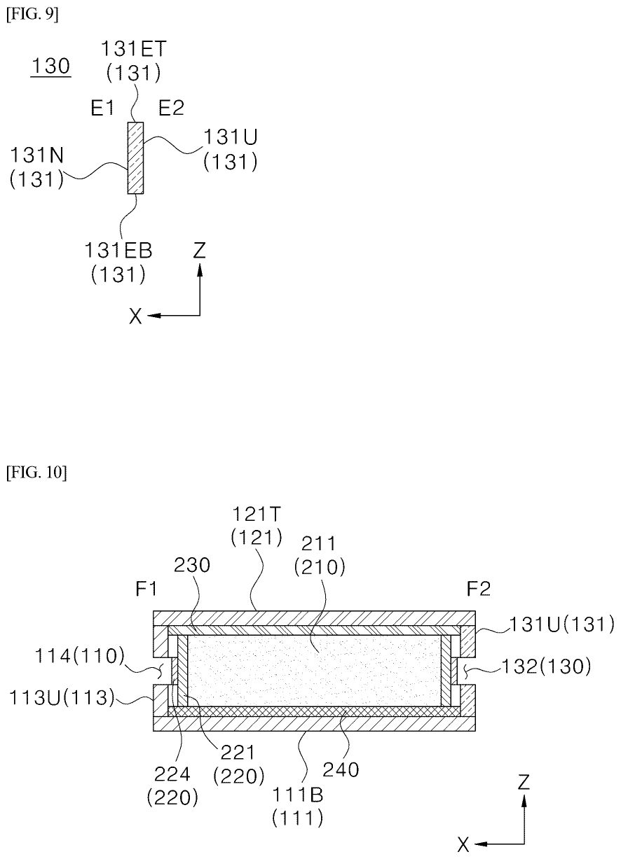

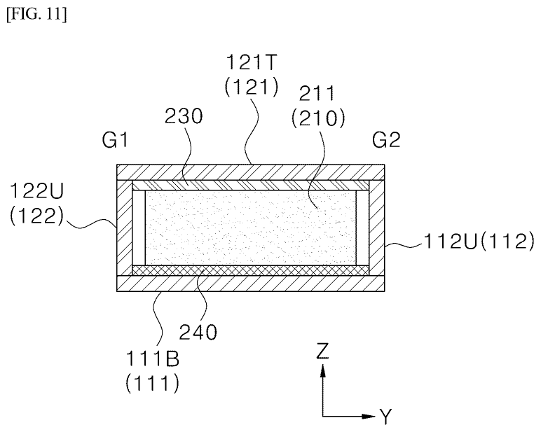

Hereinafter, embodiments of the present disclosure will be described in detail with reference to FIGS. 1 to 11. However, these are merely illustrative and the present disclosure is not limited to the specific embodiments described as examples.

A battery module of the present disclosure may be applied to pouch cells, cylindrical cells, prismatic cells, etc. A battery cell 211 forming the battery module may be a winding type, a stacking type, a z-folding type, or a stacked-folding type.

In this specification, the coordinate system may be a Cartesian coordinate system. In this specification, the up-down direction and the front-back direction may be set based on FIG. 1.

The front-back direction may be parallel to the X-axis. For example, a positive X-axis direction may represent the forward direction, and a negative X-axis direction may represent the rearward direction.

The up-down direction may be parallel to the Z-axis. For example, a positive Z-axis direction may represent the upward direction, and a negative Z-axis direction may represent the downward direction. The Y-axis may be perpendicular to both the X-axis and the Z-axis.

The left-right direction may be parallel to the Y-axis. For example, a positive Y-axis direction may represent the right side, and a negative Y-axis direction may represent the left side. The Y-axis may be perpendicular to both the X-axis and the Z-axis.

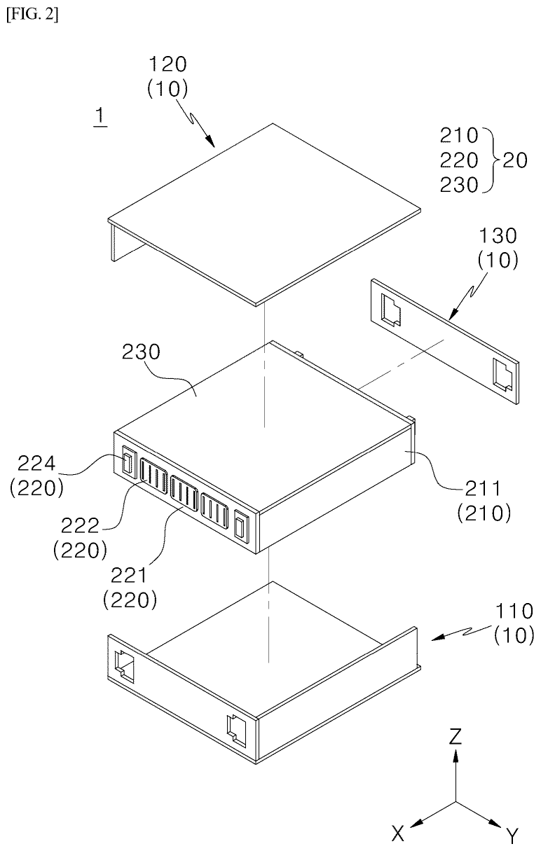

Referring to FIGS. 1 and 2, a battery module 1 may be arranged along the front-back direction. The longitudinal direction of the battery module 1 may be parallel to the front-back direction. The lateral direction of the battery module 1 may be parallel to the left-right direction. The height direction of the battery module 1 may be parallel to the up-down direction.

The battery module 1 may include a battery case 10. The battery case 10 may form the exterior of the battery module 1. For example, the periphery of the battery case 10 may form the periphery of the battery module 1.

The front and rear portions of the battery case 10 may define the front and rear surfaces of the battery module 1. The upper and lower portions of the battery case 10 may define the upper and lower surfaces of the battery module 1. The left and right portions of the battery case 10 may define the left and right surfaces of the battery module 1.

The upper portion of the battery case 10 may face or be oriented upward. The lower portion of the battery case 10 may face or be oriented downward. The upper portion and lower portion of the battery case 10 may be spaced apart from each other vertically. A battery assembly 20 may be disposed between the upper portion and lower portion of the battery case 10.

The front portion of the battery case 10 may face or be oriented toward the front. The rear portion of the battery case 10 may face or be oriented toward the back. The front and rear portions of the battery case 10 may be spaced apart from each other in the front-back direction. The battery assembly 20 may be disposed between the front and rear portions of the battery case 10.

The battery module 1 may include the battery assembly 20. The battery assembly 20 may be accommodated in the battery case 10. The exterior surface of the battery assembly 20 may include an upper surface, a lower surface, and a peripheral surface. The peripheral surface may connect the upper surface and the lower surface.

The upper surface of the battery assembly 20 may face or be oriented upward. The upper surface of the battery assembly 20 may face or contact the inner surface of the upper portion of the battery case 10. The lower surface of the battery assembly 20 may face or be oriented downward.

The lower surface of the battery assembly 20 may face or contact the inner surface of the lower portion of the battery case 10. The peripheral surface of the battery assembly 20 may face or contact the inner surface of the periphery of the battery case 10.

The battery assembly 20 may be arranged along the front-back direction. The longitudinal direction of the battery assembly 20 may be parallel to the front-back direction. The lateral direction of the battery assembly 20 may be parallel to the left-right direction. The height direction of the battery assembly 20 may be parallel to the up-down direction.

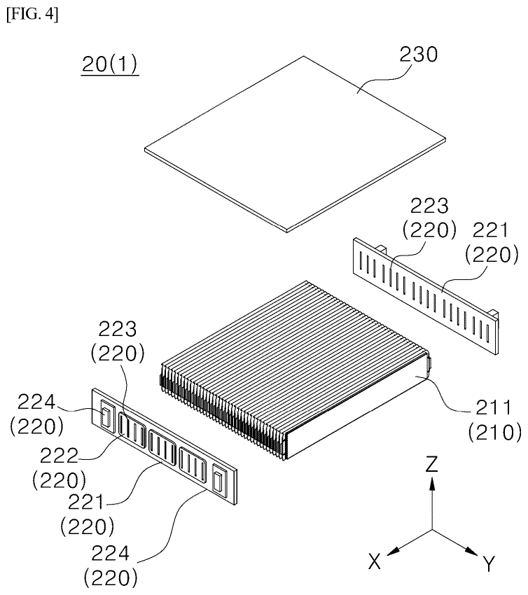

Referring to FIG. 4, the battery assembly 20 may include a cell assembly 210.

The cell assembly 210 may include a plurality of battery cells 211. The battery cells 211 may extend along one direction. For example, the battery cells 211 may extend from one end to the other end in the longitudinal direction of the battery module 1. The distance between one surface and the other surface of the battery cell 211 may correspond to the thickness of the battery cell 211.

A plurality of battery cells 211 may be provided. The plurality of battery cells 211 may be stacked along one direction. For example, the plurality of battery cells 211 may be stacked along the lateral direction of the battery module 1. For example, the plurality of battery cells 211 may be stacked along the thickness direction of the battery cell 211.

The battery assembly 20 may include a busbar assembly 220. The busbar assembly 220 may form at least one of the front and rear portions of the battery assembly 20. For example, the battery assembly 20 including the cell assembly 210 having electrode tabs formed in only one direction may include the busbar assembly 220 disposed on only one of the front and rear portions of the battery assembly 20.

The busbar assembly 220 may be connected or coupled to the cell assembly 210. For example, the busbar assembly 220 may be connected or coupled to the front of the cell assembly 210.

The busbar assembly 220 may include a busbar plate 221. The busbar plate 221 may have a plate or board shape. The front surface of the busbar plate 221 may face or be oriented toward the front. The rear surface of the busbar plate 221 may face or be oriented toward the front surface of the cell assembly 210.

The busbar assembly 220 may include a busbar 222. The busbar 222 may be disposed on the busbar plate 221. For example, the busbar 222 may be formed to protrude from the front surface of the busbar plate 221. The busbar 222 may electrically connect the plurality of battery cells 211.

A plurality of slits 223 may be formed through the busbar plate 221 and the busbar 222. Electrode tabs of the plurality of battery cells 211 may pass through the plurality of slits 223 and be electrically coupled to the busbar 222.

The busbar assembly 220 may include an external terminal 224. The external terminal 224 may be connected or coupled to the busbar 222. For example, the external terminal 224 may extend from the busbar 222 along the longitudinal direction of the battery module 1.

The battery assembly 20 may include a sensing module 230. The sensing module 230 may form the upper surface of the battery assembly 20. The sensing module 230 may be connected or coupled to the cell assembly 210. For example, the sensing module 230 may be disposed on top of the cell assembly 210.

Referring to FIGS. 4 and 10, the battery assembly 20 may include a buffer module 240. The buffer module 240 may be connected or coupled to the cell assembly 210. For example, the buffer module 240 may be disposed in close contact beneath the cell assembly 210.

The buffer module 240 may be disposed between the cell assembly 210 and the battery case 10. For example, the buffer module 240 may be disposed between the lower surface of the cell assembly 210 and the upper surface of the lower portion of the battery case 10.

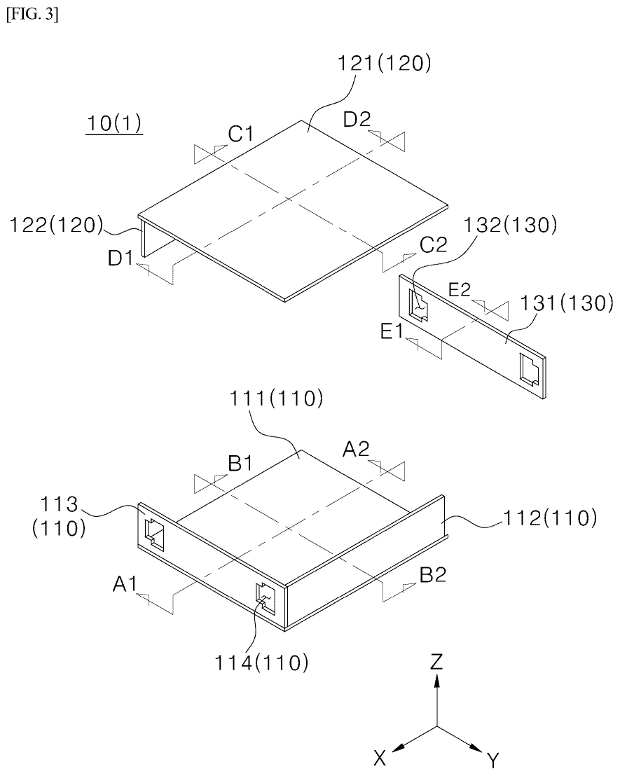

Referring to FIGS. 2 and 3, the battery case 10 may be divided into a plurality of cases. For example, the battery case 10 may be divided into three segments. For example, the battery case 10 may be divided into three separate cases.

The battery case 10 may include a main case 110. The main case 110 may be open at three sides corresponding to the X-axis, Y-axis, and Z-axis. For example, the main case 110 may define an open shape allowing access along the X-axis, Y-axis, and Z-axis.

The main case 110 may be open upward. For example, the main case 110 may be open along the positive Z-axis. The main case 110 may be open backward. For example, the main case 110 may be open along the negative X-axis. The main case 110 may be open laterally. For example, the main case 110 may be open along the negative Y-axis.

The main case 110 may block some surfaces of the battery assembly 20 from the outside. For example, the main case 110 may block the lower surface and some peripheral surfaces of the battery assembly 20 from the outside.

The main case 110 may include a main case base 111. The main case base 111 may be disposed in the XY plane. The upper surface of the main case base 111 may face or be oriented upward. For example, the upper surface of the main case base 111 may face or be oriented toward the lower surface of the battery assembly 20.

The main case base 111 may extend from one side to the other side. For example, the main case 110 may extend from a first side to a second side. The first side may correspond to the right side of the battery case 10, and the second side may correspond to the left side of the battery case 10.

Referring to FIGS. 3 to 6, the main case base 111 may include a main case base lower surface 111B. The main case base lower surface 111B may face or be oriented downward. The main case base 111 may include a main case base upper surface 111T. The main case base upper surface 111T may face or be oriented upward. For example, the main case base upper surface 111T may face or be oriented toward the lower surface of the battery assembly 20.

The main case base 111 may include a main case rear edge 111ER. The main case rear edge 111ER may connect the rear side of the main case base upper surface 111T and the rear side of the main case base lower surface 111B.

The main case base 111 may include a main case side edge 111ES. The main case side edge 111ES may connect the lateral side of the main case base upper surface 111T and the lateral side of the main case base lower surface 111B.

The main case base 111 may block some surfaces of the battery assembly 20 from the outside. For example, the main case base 111 may block the lower surface of the battery assembly 20 from the outside. The battery assembly 20 may be placed on the upper surface of the main case base 111. The battery assembly 20 may be seated on the upper surface of the main case base 111.

The main case 110 may include a first main case plate 112. The first main case plate 112 may be disposed in the XZ plane. The outer surface of the first main case plate 112 may face or be oriented toward the right side. The first main case plate 112 may block the right side of the battery assembly 20 from the outside.

The first main case plate 112 may be disposed on the main case base 111. For example, the first main case plate 112 may be connected or coupled to the upper surface of the main case base 111.

For example, the first main case plate 112 may extend upward on the upper right side of the main case base 111. For example, the first main case plate 112 may extend in the front-back direction.

The main case base 111 and the first main case plate 112 may be integrally formed. For example, the main case base 111 and the first main case plate 112 may be formed from a single sheet material. For example, the main case base 111 and the first main case plate 112 may be formed by bending a single sheet through a process such as pressing.

The first main case plate 112 may include a first main case plate inner surface 112N. The first main case plate inner surface 112N may face or be oriented toward the side surface of the battery assembly 20. For example, the first main case plate inner surface 112N may face or be oriented toward the side surface of the cell assembly 210. For example, a battery cell disposed at the outermost side of the plurality of battery cells 211 forming the cell assembly 210 may face or be oriented toward the inner surface of the first main case plate 112.

The first main case plate 112 may include a first main case plate outer surface 112U. The first main case plate outer surface 112U may face or be oriented toward the right side. The first main case plate 112 may include a first main case plate edge 112E. The first main case plate edge 112E may define the upper end of the first main case plate 112.

The main case 110 may include a second main case plate 113. The second main case plate 113 may be disposed in the YZ plane. The outer surface of the second main case plate 113 may face or be oriented toward the front. The second main case plate 113 may block the front surface of the battery assembly 20 from the outside.

The second main case plate 113 may be disposed on the main case base 111. For example, the second main case plate 113 may be connected or coupled to the upper surface of the main case base 111. For example, the second main case plate 113 may extend upward from the upper front side of the main case base 111. For example, the second main case plate 113 may be formed to extend in the left-right direction.

The second main case plate 113 may include a second main case plate inner surface 113N. The second main case plate inner surface 113N may face or be oriented toward the side surface of the battery assembly 20.

The second main case plate 113 may include a second main case plate outer surface 113U. The second main case plate outer surface 113U may face or be oriented toward the front.

The second main case plate 113 may include a second main case plate edge 113E. The second main case plate edge 113E may define the upper end of the second main case plate 113.

The first main case plate 112 and the second main case plate 113 may be connected or coupled. For example, the front side of the first main case plate 112 and the right side of the second main case plate 113 may be connected or coupled to each other.

The first main case plate 112 and the second main case plate 113 may form a bent shape together. For example, the first main case plate 112 and the second main case plate 113 may be coupled orthogonally at a coupling point.

The first main case plate 112 and the second main case plate 113 may function to block some side surfaces of the battery assembly 20. For example, the first main case plate 112 and the second main case plate 113 may inhibit movement of the battery assembly 20 in the positive X-axis direction and the Y-axis direction.

The main case 110 may include a main case through-hole 114. The main case through-hole 114 may be formed in the second main case plate 113. The main case through-hole 114 may be formed as a hole penetrating the second main case plate 113.

The main case through-hole 114 may extend between the front surface and the rear surface of the second main case plate 113. The main case through-hole 114 may allow communication between the front of the main case 110 and the interior of the main case 110. The main case through-hole 114 may enable electrical connection to the external terminal 224.

During the process of attaching the battery assembly 20 to the battery case 10, the main case 110 may allow free insertion of the battery assembly 20. For example, the battery assembly 20 may enter the main case 110 from any of the X, Y, or Z axes directions.

For example, the battery assembly 20 may enter the main case 110 downward from the top. For example, the battery assembly 20 may enter the main case 110 forward from the back. For example, the battery assembly 20 may enter the main case 110 rightward from the left side.

The battery module 1 according to the present disclosure may provide a three-segment structure of the battery case 10. For example, when the battery assembly 20 is seated in the main case 110, it may be inserted without restriction along any of the X, Y, or Z axes, facilitating insertion of the battery assembly 20.

The longitudinal direction of the battery assembly 20 may be parallel to the longitudinal direction of the battery case 10. The lower surface of the battery assembly 20 may face or be oriented toward the main case base upper surface 111T. The front surface of the battery assembly 20 may face or be oriented toward the second main case plate inner surface 113N. The right side surface of the battery assembly 20 may face or be oriented toward the first main case plate inner surface 112N.

Referring to FIGS. 3 to 8, the battery case 10 may include a middle case 120. The middle case 120 may be coupled to the main case 110. The middle case 120 may close some open regions of the main case 110. For example, the middle case 120 may block the open upper region and the open left region of the main case 110 from the outside.

The middle case 120 may block some surfaces of the battery assembly 20 from the outside. For example, the middle case 120 may block the upper and left surfaces of the battery assembly 20 from the outside.

The middle case 120 may include a middle case base 121. The middle case base 121 may be disposed in the XY plane. The outer surface of the middle case base 121 may face or be oriented upward. The lower surface of the middle case base 121 may face or be oriented toward the upper surface of the battery assembly 20.

The middle case base 121 may include a middle case base lower surface 121B. The middle case base lower surface 121B may face or be oriented downward. The middle case base lower surface 121B may face or be oriented toward the upper surface of the battery assembly 20.

The middle case base 121 may include a middle case base upper surface 121T. The middle case base upper surface 121T may face or be oriented upward. The middle case base 121 may include a middle case base edge 121E.

The middle case base edge 121E may connect the side edge of the middle case base upper surface 121T to the side edge of the middle case base lower surface 121B. The middle case base edge 121E may be joined by laser welding to the first main case plate edge 112E.

The middle case base 121 may include a middle case base front edge 121EF and a middle case base rear edge 121ER. The middle case base front edge 121EF and the middle case base rear edge 121ER may define the front end and the rear end of the middle case base 121, respectively.

The middle case base front edge 121EF may be joined by laser welding to the second main case plate 113. The middle case base rear edge 121ER may be joined by laser welding to the cover case plate top edge 131ET.

The middle case base 121 may block some surfaces of the battery assembly 20 from the outside. For example, the middle case base 121 may block the upper surface of the battery assembly 20 from the outside.

The middle case base 121 and the first main case plate 112 may be connected or coupled. For example, the right side of the middle case base 121 and the upper side of the first main case plate 112 may be connected or coupled to each other.

The middle case base 121 and the second main case plate 113 may be connected or coupled. For example, the front side of the middle case base 121 and the upper side of the second main case plate 113 may be connected or coupled to each other.

The middle case 120 may include a middle case plate 122. The middle case plate 122 may be disposed in the XZ plane. The outer surface of the middle case plate 122 may face or be oriented toward the left side. The inner surface of the middle case plate 122 may face or be oriented toward the side surface of the battery assembly 20.

The middle case plate 122 may be disposed on the middle case base 121. For example, the middle case plate 122 may be connected or coupled to the lower surface of the middle case base 121. For example, the middle case plate 122 may extend downward from the lower left side of the middle case base 121. For example, the middle case plate 122 may be formed along the front-back direction.

The middle case base 121 and the middle case plate 122 may be integrally formed. For example, the middle case base 121 and the middle case plate 122 may be formed from a single sheet of material. For example, the middle case base 121 and the middle case plate 122 may be formed by bending a single sheet through a process such as pressing.

When the battery assembly 20 is seated on the main case 110 including the integrally formed main case base 111 and the first main case plate 112, the middle case 120 including the integrally formed middle case base 121 and the middle case plate 122 may be coupled to the main case 110.

Through this, the left-right and up-down movements of the battery assembly 20 may be suppressed. For example, by combining the main case 110 and the middle case 120, the seating and restriction of movement for assembly of the battery assembly 20 may be carried out in a simplified process.

The middle case plate 122 may block some surfaces of the battery assembly 20 from the outside. For example, the middle case plate 122 may block the left surface of the battery assembly 20 from the outside.

The middle case plate 122 may include a middle case plate inner surface 122N. The middle case plate inner surface 122N may face or be oriented toward the side surface of the battery assembly 20.

The middle case plate 122 may include a middle case plate outer surface 122U. The middle case plate outer surface 122U may face or be oriented toward the left side. The middle case plate 122 may include a middle case plate edge 122E. The middle case plate edge 122E may define the lower end of the middle case plate 122. The middle case plate edge 122E may be joined by laser welding to the main case side edge 111ES.

The middle case base 121 and the middle case plate 122 may be connected or coupled. For example, the left side of the middle case base 121 and the upper side of the middle case plate 122 may be connected or coupled to each other.

The middle case base 121 and the middle case plate 122 may form a bent shape together. For example, the middle case base 121 and the middle case plate 122 may be coupled orthogonally at a coupling point.

The middle case plate 122 and the main case base 111 may be connected or coupled. For example, the lower side of the middle case plate 122 may be connected or coupled to the left side of the main case base 111.

The middle case plate 122 and the second main case plate 113 may be connected or coupled. For example, the front side of the middle case plate 122 may be connected or coupled to the left side of the second main case plate 113.

During the process of coupling the middle case 120 to the main case 110, the middle case base 121 may cover the upper surface of the battery assembly 20. The middle case plate 122 may cover the left surface of the battery assembly 20.

When the battery assembly 20 is seated in the main case 110 without any constraints along the X, Y, or Z axes, the middle case 120 may be assembled to the main case 110.

When the middle case 120 is assembled to the main case 110, the movement of the battery assembly 20 along two axes seated on the main case 110 may be suppressed. For example, the middle case base 121 may prevent the battery assembly 20 seated on the main case 110 from dislodging in the positive Z-axis direction. For example, the middle case plate 122 may prevent the battery assembly 20 seated on the main case 110 from dislodging in the negative Y-axis direction.

The main case 110 and the middle case 120 may have the same shape. For example, the battery case 10 may form a peripheral surface using a pair of members having the same shape.

One of the pair of members may be a combination of the main case base 111 and the first main case plate 112. The other of the pair of members may be a combination of the middle case base 121 and the middle case plate 122.

For example, the combined shape of the main case base 111 and the first main case plate 112 may be identical to the combined shape of the middle case base 121 and the middle case plate 122.

For example, when set based on an imaginary line that runs parallel to the longitudinal direction of the battery module 1 and passes through the center of the battery case 10, the combined shape of the main case base 111 and the first main case plate 112 may be symmetrical to the combined shape of the middle case base 121 and the middle case plate 122.

The shapes of the second main case plate 113 and the cover case plate 131 may be identical. The front and rear surfaces of the battery case 10 may be formed using the second main case plate 113 and the cover case plate 131. The battery case 10 according to the present disclosure may form a peripheral surface and front and rear surfaces by combining two pairs of members having the same shape.

The battery case 10 may include a cover case 130. The cover case 130 may be coupled to the main case 110 and the middle case 120. The cover case 130 may close the open region of the battery case 10.

For example, the cover case 130 may block the rear region of the main case 110 from the outside. For example, the cover case 130 may close the open rear region of the battery case 10.

Referring to FIGS. 3 to 9, the cover case 130 may include a cover case plate 131. The cover case plate 131 may be disposed in the YZ plane. The outer surface of the cover case plate 131 may face or be oriented toward the rear. The inner surface of the cover case plate 131 may face or be oriented toward the rear of the battery assembly 20.

The cover case plate 131 may include a cover case plate inner surface 131N. The cover case plate inner surface 131N may face or be oriented toward the rear of the battery assembly 20.

The cover case plate 131 may include a cover case plate outer surface 131U. The cover case plate outer surface 131U may face or be oriented toward the rear. The cover case plate 131 may include a cover case plate top edge 131ET and a cover case plate bottom edge 131EB.

The cover case plate top edge 131ET and the cover case plate bottom edge 131EB may define the upper and lower ends of the cover case plate 131, respectively. The cover case plate bottom edge 131EB may be joined by laser welding to the main case rear edge 111ER.

The cover case plate 131 may function to block some surfaces of the battery assembly 20. For example, the cover case plate 131 may block the rear surface of the battery assembly 20.

The cover case plate 131 and the main case base 111 may be connected or coupled. For example, the lower side of the cover case plate 131 may be connected or coupled to the rear side of the main case base 111.

The cover case plate 131 and the first main case plate 112 may be connected or coupled. For example, the right side of the cover case plate 131 may be connected or coupled to the rear side of the first main case plate 112.

The cover case plate 131 and the middle case base 121 may be connected or coupled. For example, the upper side of the cover case plate 131 may be connected or coupled to the rear side of the middle case base 121.

The cover case plate 131 and the middle case plate 122 may be connected or coupled. For example, the left side of the cover case plate 131 may be connected or coupled to the rear side of the middle case plate 122.

The cover case 130 may include a cover case through-hole 132. The cover case through-hole 132 may be formed in the cover case plate 131. The cover case through-hole 132 may have a through-hole formed in the cover case plate 131.

The cover case through-hole 132 may extend between the front surface and the rear surface of the cover case plate 131. The cover case through-hole 132 may allow communication between the rear of the cover case 130 and the interior of the main case 110. The cover case through-hole 132 may enable electrical connection to the external terminal 224.

After the middle case 120 is attached to the main case 110, the rear of the battery case 10 may remain open. For example, the interior of the battery case 10 may be open toward the rear side. By assembling the cover case 130 to the battery case 10, the battery case 10 may be closed in all directions.

For example, the cover case 130 may secure the battery assembly 20 seated on the main case 110 and the middle case 120. For example, the cover case 130 may suppress movement of the battery assembly 20 along the front-back direction. For example, the cover case plate 131 may prevent the battery assembly 20 seated on the main case 110 and the middle case 120 from dislodging in the negative X-axis direction.

While the battery case and battery module according to embodiments of the present invention have been described with reference to specific embodiments, these are merely illustrative examples, and the present invention is not limited thereto, and should be construed to have the broadest scope consistent with the basic concepts disclosed herein.

What is claimed is:

1. A battery case comprising:
a main case comprising a main case base extending from a first side to a second side, a first main case plate coupled to the first side of the main case base, and a second main case plate forming a front surface of the battery case and coupled to the main case base;
a middle case comprising a middle case base disposed above the main case base, and a middle case plate coupled to the second side of the middle case base; and
a cover case forming a rear surface of the battery case and coupled to both the main case and the middle case.

2. The battery case according to claim 1, wherein the first main case plate and the second main case plate form a peripheral surface of the battery case.

3. The battery case according to claim 1, wherein the main case base and the first main case plate are integrally formed.

4. The battery case according to claim 1, wherein the middle case base and the middle case plate are integrally formed.

5. The battery case according to claim 1, wherein an edge of the first side of the middle case base is coupled to an upper end of the first main case plate, and
a lower end of the middle case plate is coupled to an edge of the second side of the main case base.

6. The battery case according to claim 5, wherein the main case and the middle case are laser welded.

7. The battery case according to claim 1, wherein an upper end of the cover case is coupled to a rear end of the middle case base, and
a lower end of the cover case is coupled to a rear end of the main case base.

8. The battery case according to claim 7, wherein the combined shape of the main case base and the first main case plate is identical to the combined shape of the middle case base and the middle case plate.

9. A battery module comprising:
a battery case; and
a battery assembly accommodated in the battery case,
wherein the battery case is divided into three segments.

10. The battery module according to claim 9, wherein the battery case comprises:
a main case in which the battery assembly is seated and is open to the outside;
a middle case coupled to the main case and covering upper and side surfaces of the battery assembly; and
a cover case coupled to the main case and the middle case and covering a rear surface of the battery assembly.

11. The battery module according to claim 9, wherein the battery assembly comprises a cell assembly comprising a plurality of battery cells, and
the plurality of battery cells are stacked along a lateral direction of the battery case.

12. The battery module according to claim 11, further comprising a busbar assembly coupled to the cell assembly, and
wherein the busbar assembly forms a front surface or a rear surface of the battery assembly.

13. The battery module according to claim 10, wherein the main case comprises:
a main case base extending from a first side to a second side;
a first main case plate coupled to the first side of the main case base; and
a second main case plate forming a front surface of the battery case and coupled to the main case base.

14. The battery module according to claim 13, wherein the middle case comprises:
a middle case base disposed above the main case base; and
a middle case plate coupled to the second side of the middle case base.

15. The battery module according to claim 14, wherein an edge of the first side of the middle case base is coupled to an upper end of the first main case plate, and
a lower end of the middle case plate is coupled to an edge of the second side of the main case base.

16. The battery module according to claim 13, wherein the main case further comprises a main case through-hole formed through the second main case plate, and
wherein the main case through-hole allows communication between the battery assembly and the exterior of the battery case.

17. The battery module according to claim 13, wherein a battery cell disposed at the outermost side of the plurality of battery cells faces an inner surface of the first main case plate.

18. The battery module according to claim 14, wherein the main case base and the first main case plate are integrally formed, and
the middle case base and the middle case plate are integrally formed.

19. The battery module according to claim 14, wherein the main case and the middle case are laser welded.

20. The battery module according to claim 14, wherein, based on an imaginary line that runs parallel to the longitudinal direction of the battery module and passes through the center of the battery case,
the combined shape of the main case base and the first main case plate is symmetrical to the combined shape of the middle case base and the middle case plate.
